(19) United States
(12) Patent Application Publication
(10) Pub. No.: US 2006/0016856 A1
(43) Pub. Date: Jan. 26, 2006

(54) Apparatus and method for sealing a container

(76) Inventors: Eric D. Larsen, Idaho Falls, ID (US); Arthur D. Watkins, Idaho Falls, ID (US); David P. Pace, Idaho Falls, ID (US); Rodney J. Bitsoi, Ririe, ID (US); Timothy R. McJunkin, Idaho Falls, ID (US)

Correspondence Address: Alan D. Kirsch;BBWI, PO BOX 1625, IDAHO FALLS, ID, 83415-3899, US

(21) Appl. No.: 10/958,513

(22) Filed: Oct. 4, 2004

Related U.S. Application Data
(63) Continuation-in-part of application No. 10/896,411, filed on Jul. 21, 2004, now Pat. No. 6,949,005.

(51) Int. Cl. A47J 36/02

(52) U.S. Cl. 228/101

(57) ABSTRACT

An apparatus and method for sealing a container is described and which includes multiple work stations which are positioned on a moveable carousel, and wherein the individual work stations are operable to form a seal on a container which encloses hazardous waste and wherein the seal can be readily inspected and repaired, if a defective seal has been formed.

### RELATED APPLICATION

This application is a continuation-in-part of U.S. patent application Ser. No. 10/896,411, filed on Jul. 21, 2004, entitled “Grinding Assembly, Grinding Apparatus, Well Joint Defect Repair System, and Method.”

### GOVERNMENT RIGHTS

This invention was made with Government support under Contract DE-AC07-99ID13727 awarded by the U.S. Department of Energy. The Government has certain rights in the invention.

### TECHNICAL FIELD

The present invention relates to an apparatus for sealing containers, and a method for implementing same, and more specifically to an apparatus which includes a rotating carousel which carries a plurality of work stations and which are operable to remotely seal a canister carrying hazardous waste in a fashion not possible heretofore.

### BACKGROUND OF THE INVENTION

The nuclear industry has long struggled with the issues surrounding the handling and disposal of nuclear waste.

It should be understood that hazardous materials, such as nuclear waste, are typically sealed into metal containers for long term storage, and to prevent such materials from escaping into the immediate ambient environment. Heretofore, canisters or containers of this type were sealed by personnel in environments called “hot cells,” that is, rooms having thick walls and windows where work can be safely done with radioactive materials that might be detrimental to humans. Notwithstanding the safeguards that have been developed, the present system for handling nuclear waste, and sealing the same in such containers has been less than ideal.

In addition to the problems of potential exposure of personnel to the hazardous waste being sealed in such storage containers, there are further problems in the prior art practices and which concern whether the containers, once sealed, potentially have defective seals, and which could readily fail or open, once the containers are moved into a suitable storage facility to expose the contents of such containers to the ambient environment.

It would be desirable therefore to have an apparatus and method for sealing a container, and which provides a convenient means whereby containers of this sort could be readily sealed, inspected, and otherwise repaired in the event that a defective seal is detected during the sealing process.

### SUMMARY OF THE INVENTION

A first aspect of the present invention relates to an apparatus for sealing a container and which includes a first work station which supports a container to be sealed; a moveable carousel which rotates about the first work station; a second work station borne by the moveable carousel, and which creates a seal on the container; a third work station borne by the moveable carousel, and which inspects the seal made by the second work station and identifies any defect in the seal; and a fourth work station borne by the moveable carousel, and which removes a region of the seal which includes the identified defect, and wherein the carousel selectively rotates to a position where the second work station can reapply the seal in the region of the seal which has been removed, and wherein subsequent to the reapplication of the seal, the carousel selectively rotates to a position where the region of the seal which has been previously removed, and reapplied is reinspected to identify any remaining defects in the seal.

Another aspect of the present invention relates to an apparatus for sealing a container which includes a first work station for supporting a metal container in a working position, and which encloses a material which emits hazardous radiation; a radiation shield which surrounds the first work station, and wherein a portion of the metal container extends above the radiation shield; a moveable carousel which selectively rotates about the first work station; a second work station, borne by the moveable carousel, and which mounts a remotely controllable welding apparatus for forming a welding bead which seals the container, and wherein the welding apparatus is located in a position above the radiation shield when the welding bead is being formed, and is further moveable to a protected position below the radiation shield when the welding apparatus is not forming the welding bead, and wherein the moveable carousel selectively moves the welding apparatus around the metal container to form the welding bead; a third work station, borne by the moveable carousel, and which is positioned in spaced relation relative to the second work station, and wherein a remotely controllable inspection device is borne by the third work station and is positioned above the radiation shield, and is further configured to detect a defect in the welding bead formed by the second work station when positioned above the radiation shield, and is further moveable to a protected position below the radiation shield when the inspection device is not being employed to detect a defect in the welding bead; a fourth work station, borne by the movable carousel, and which is positioned in spaced relation relative to the first and second work stations, and wherein a remotely controllable removal device is borne by the fourth work station, and is positioned above the radiation shield, and is configured to remove, at least in part, any defect which has been detected in the welding bead formed by the second work station, and is further moveable to a protected position below the radiation shield when the removal device is not in use; and a computer borne by the carousel and which is substantially protected from the hazardous radiation emitted by the material enclosed within the metal container by the radiation shield, and wherein the computer is coupled in controlling relation relative to the second, third and fourth work stations.

Another aspect of the present invention relates to a method for sealing a container and which includes providing a container to be sealed and which encloses waste material which emits hazardous radiation; providing a carousel which selectively rotates about the container to be sealed; providing a device which is borne by the carousel, and which is configured to seal the container; and operating the carousel, and the device, from a remote location to seal the container, and prevent an operator from being exposed to the emitted hazardous radiation.

Yet further, another aspect of the present invention relates to a method for sealing a container and which includes providing an enclosure which shields an operator from hazardous radiation; providing a first work station within the enclosure, and which supports a metal container which must be sealed, and which encloses a material that emits hazardous radiation; providing a carousel which selectively rotates about the first work station; providing a second welding station, mounted on the carousel, and which is configured to seal the metal container by depositing a welding bead on the metal container; providing a third inspection station, mounted on the carousel, and which inspects the welding bead formed on the metal container to detect significant flaws in the welding bead; providing a fourth removal station, mounted on the carousel, and which removes, at least in part, any of the significant flaws found in the welding bead; providing at least one controller which is controllably coupled with the carousel, second, third, and fourth repair stations; and individually operating the carousel, second, third and fourth work stations, from a location which is remote from the enclosure, and in a fashion so as to substantially seal the hazardous material within the metal container by means of a welding bead which has substantially no significant flaws.

These and other aspects of the present invention will be discussed in greater detail hereinafter.

### BRIEF DESCRIPTION OF THE DRAWINGS

Preferred embodiments of the invention are described below with reference to the following accompanying drawings. Some surfaces have been removed to show the structure thereunder.

FIG. 1 is a perspective, greatly simplified view of the apparatus for sealing a container of the present invention.

FIG. 2 is a perspective, side elevation view, of an apparatus for sealing a container of the present invention.

FIG. 3 is a greatly simplified schematic view of the control system employed with the apparatus and method of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

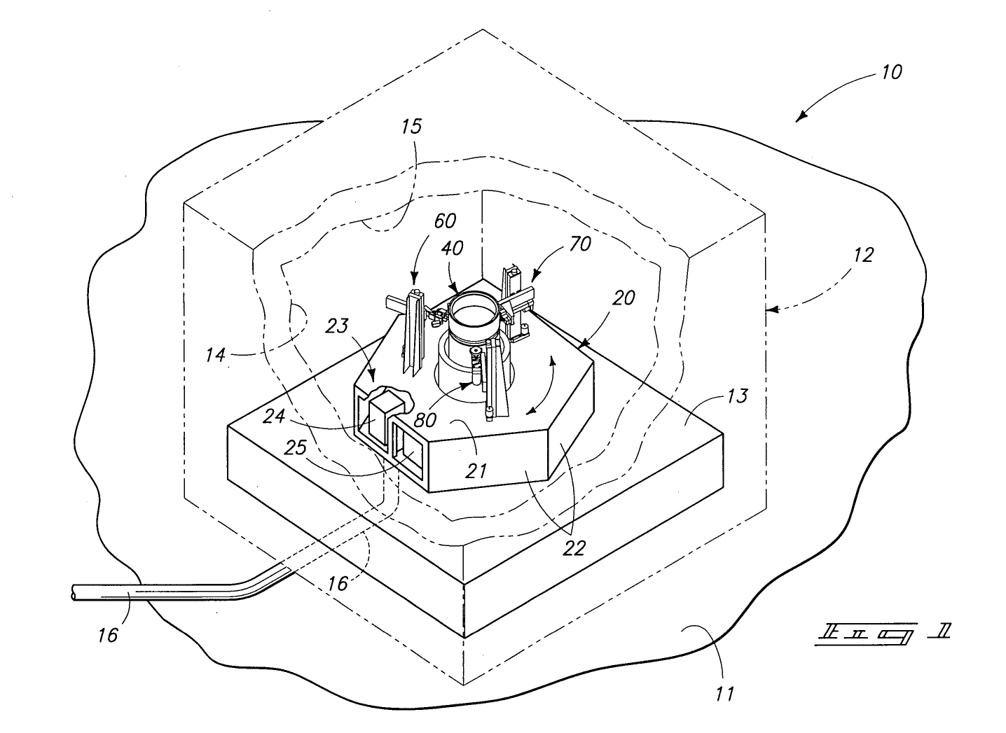

The apparatus and method for sealing a container of the present invention is generally indicated by the numeral 10 and is seen in FIG. 1 and following. As shown therein, the apparatus 10 is positioned or otherwise located on a supporting surface generally indicated by the numeral 11. The apparatus is enclosed within a “hot cell” which is also generally indicated by the numeral 12 and which is utilized to contain or otherwise confine hazardous, electromagnetic radiation from escaping into the ambient environment. Such “hot cells” are well known in the art, and typically include rather thick floors, walls, and ceilings and which are useful in confining or otherwise restraining emitted hazardous radiation so that it does not escape into ambient environment and potentially harm personnel that are nearby. In this regard, the “hot cell” has a floor 13 and sidewalls 14 which extend generally normally upwardly therefrom. A roof or ceiling 15 is provided and is sealably mated with the surrounding sidewalls 14. As seen in FIG. 1, an electrical power conduit 16 is provided and which passes through a channel formed in the floor in order to provide electrical power for use by the apparatus 10. As seen in FIG. 1, the apparatus 10 includes a rotatable carousel 20 which carries a plurality of work stations which will be discussed in greater detail hereinafter.

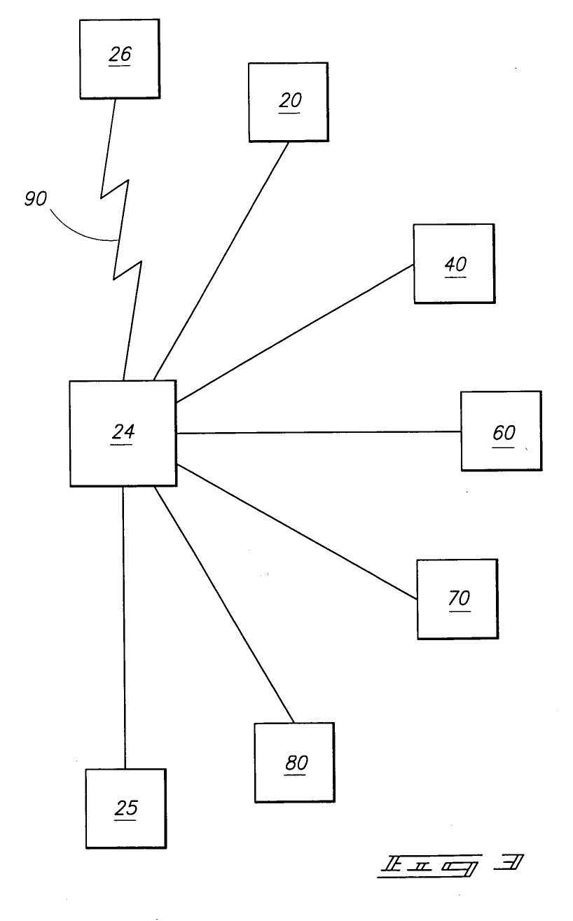

The rotatable carousel 20 has a top surface 21 which is positioned in spaced relation relative to the floor 13 of the hot cell. The rotatable carousel 20 further has a plurality of sidewalls 22 which extend generally perpendicularly downwardly relative to the top surface 21, and defines a cavity 23 therein. Mounted in the cavity of the rotatable carousel 20 is a computer 24 which is coupled to the electrical power conduit 16 and further is coupled in controlling relation relative to the work stations which will be described hereinafter. Still further, a plurality of controllers and other power supplies 25 are also received in the cavity 23 and are coupled to and controlled by the computer 24. The computer is directly controlled by way of wireless communication to a distant work station 26 as seen in FIG. 3. This permits an operator (not shown) to communicate by wireless communication to the computer in order to give it commands and to otherwise control the apparatus and method of the present invention 10. The rotatable carousel 20 includes a motor (not shown) and which drives the rotatable carousel in a given direction. The electrical power supplied by the electrical power conduit 16 enters the rotatable carousel 20 by way of slip rings which are mounted below the carousel. In the arrangement as shown, the electrical power conduit 16 provides 480 volts, 3 phase power provided through these slip rings (not shown) and then transformers (not shown) mounted within the cavity 23 steps this same voltage down to levels required for the computer, control hardware and other subsystems utilized for each of the workstations which may include other computers, motor controllers, power supplies, and signal processors as the needs arise. In the arrangement as shown, hardware and associated subsystems mounted in the cavity 23 are sealed and shielded against radiation and contamination as will be described in greater detail hereinafter.

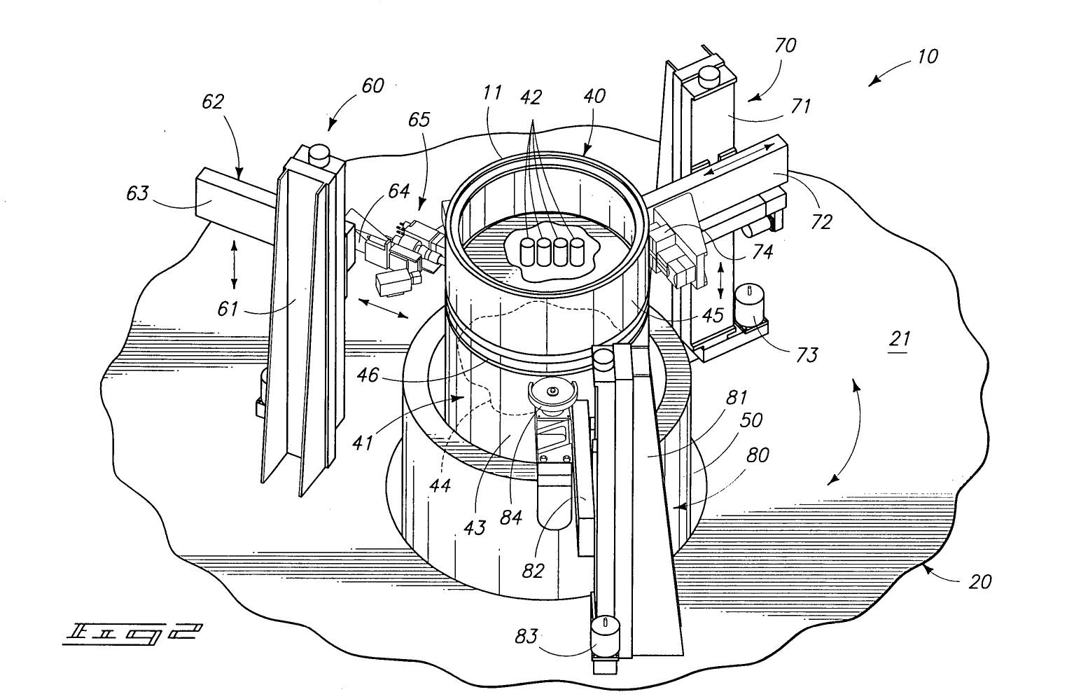

A first work station 40 is best seen by reference to FIGS. 1 and 2. The first work station is located substantially centrally relative to the rotatable carousel 20 and substantially along the rotational axis of same. The first work station as seen in FIG. 2, supports a container 41 to be sealed, and which contains waste material 42 as previously described. The container 41 enclosing the waste material 42 and which emits the hazardous radiation, is fabricated from metal, and includes a bottom portion 43 and which defines a cavity 44. Still further, the container includes a cover 45 which matingly cooperates with the bottom portion, and which completely encloses the waste material 42 which emits the hazardous radiation within the cavity. As seen in FIG. 2, the bottom portion 43 and the cover 45 when oriented in mating relation together define a seam 46 therebetween.

As best seen by reference to FIG. 2, a radiation shield 50 is positioned thereabout the container in the first work station 40. The radiation shield provides a means by which devices employed in the individual second, third and fourth work stations can be moved from a first sheltered position below the radiation shield to a second exposed position above the radiation shield. Once above the radiation shield, the various devices employed in the second, third and fourth work stations, as will be described below, may be moved into contact with the container 41 to achieve the benefits which will be described in greater detail hereinafter. As seen in FIG. 2, a portion of the metal container 41 extends above the top of the radiation shield 50 thereby permitting access to same by the second, third and fourth work stations.

A second work station 60 is provided, and is positioned on the top surface 21 of the rotatable carousel 20. The second work station 60 includes an upright tower 61 which extends generally normally upwardly relative to the top surface of the carousel, and further mounts a moveable arm 62 which moves along the tower so that the moveable arm 62 may be positioned at a location above the radiation shield 50. The moveable arm has a first portion 63 which is moveably affixed to the tower 61 and a second portion 64 which can be extended outwardly relative to the first portion and which mounts on its distal end, a welding assembly 65. As should be understood, the second work station creates a seal between the bottom portion 43 and the cover 45 of the container 41. More specifically, if the container, is fabricated from a metal, then the second work station is operable to provide a welding bead which is deposited in the seam 46 which is defined between the bottom portion of the container and the cover. Once deposited, the welding bead substantially sealably joins the bottom portion of the container 43 and the cover 45 together. A welding device or assembly 65 of the type that may be employed in the second work station 60 is seen in various U.S. Patents such as U.S. Pat. No. 6,178,819 and U.S. Pat. No. 4,712,722, both of which are incorporated by reference herein. It should be understood that the welding device or assembly employed in the second work station 60 may also include an assembly for the concurrent inspection of a partially completely weld such as what is shown in these earlier patents. Still further, this concurrent inspection may include an ultrasonic generator which generates an ultrasonic signal which is passed, at least in part, through the partially completed weld. As seen in FIG. 2, the second work station 60 which mounts the remotely controllable welding apparatus or assembly 65 for forming a welding bead is located in a position above the radiation shield 50 when the welding bead is being formed, and is further movable to a protected position below the radiation shield when the welding apparatus 65 is not forming a welding bead. Still further, it should be understood that the moveable carousel 20 is operable to be selectively moved such that the welding apparatus 65 can be selectively rotatably moved around the container 41 to form the welding bead in the seam 46. Still further, it will be recognized from a study of the drawing that the various work stations as described herein, are moveable relative to the container 41 in the X and Y axes. It being appreciated that the moveable carousel 20 causes movement of the respective work stations in the Z axis.

The apparatus and method of the present invention 10 includes a third work station which is generally indicated by the numeral 70, and which is mounted on the top surface 21 of the rotatable carousel 20 and which is further disposed in spaced relation relative to the second work station 60. The third work station 70 which is borne by the moveable carousel 20, inspects the seal, or welding bead as formed by the second work station and is additionally operable to identify any defects in the seal which would permit the escape of any of the hazardous material 42 which is enclosed within the container 41. The third work station 70 has a tower 71 which mounts a moveable arm 72 which is operable to move along the tower. Still further, a motor 73 is mounted at the base of the tower and is operable to drive the moveable arm 72 to a position where it can be located above the radiation shield 75. The moveable arm 72 carries an inspection assembly 74 which may take on several different forms including one or more inspection tools which are selected from the group which includes ultrasonic energy, eddy current, laser and visual inspection devices. These are all well known in the art and are outlined in many U.S. Patents including U.S. Pat. No. 6,178,819, 4,712,722 and 6,365,873 to name a few. The aforementioned patents are all incorporated by reference herein. Again as was described with respect to the second work station 60, the remotely controllable inspection device 74 is positioned above the radiation shield 50 and is further configured to detect a defect in the welding bead formed by the second work station 60 when positioned above the radiation shield. Still further, the inspection device 74 is moveable to a protected position below the radiation shield 50 when the inspection device is not being employed to detect the defect in the welding bead.

Mounted on the top surface 21 of the carousel 20 and spaced from the third work station 70, is a fourth work station which is generally indicated by the numeral 80. The fourth work station removes a region of the seal formed by the second work station 60 and which includes any defect as previously identified by the third work station 70. In this regard, the fourth work station includes a tower 81 including a moveable arm 82. A motor 83 is mounted at the base of the tower 81 and selectively drives the moveable arm 82 along the tower. The fourth work station mounts a repair assembly, here shown as a remotely controllable grinder 84, and which is configured to remove, at least in part, any defect which has been detected in the welding bead formed in the seam 46 and which has been previously formed by the second work station 60. Still further, much like the second and third work stations, the remotely controllable grinder or repair assembly 84 is moveable from a protected position below the radiation shield 50, when the device is not in use, and further is moveable to a position above the radiation shield such that repairs can be made. In the arrangement as shown in FIG. 2, the remotely controllable repair assembly, here shown as a grinder 84, removes a region of the welding bead having the defect as previously identified by the third work station 70 by implementing a grinding profile which is supplied by the computer 24 to the remotely controllable grinder 84. This process is described more fully in co-pending application Ser. No. 10/896,411, and which is incorporated by reference herein.

The apparatus 10 as shown, and described is operable to implement a method for sealing a container 41 as described, below. In this regard, the method for sealing the container 41 includes a first step of providing an enclosure, here illustrated as a hot cell 12, and which shields a remote operator positioned at a work station 26 from hazardous radiation. The method further includes a step of providing a first work station 60 within the enclosure 12, and which supports a metal container 41 which must be sealed and which encloses a material 42 that emits hazardous radiation. The method further includes a step of providing a carousel 20 which selectively rotates about the first work station 60. The method further includes an additional step of providing a second welding station 70 mounted on the carousel 20 and which is configured to seal the metal container 41 by depositing a welding bead on the metal container. After providing a welding bead on the metal container, the method further includes a step of providing a third inspection station 70 and which inspects the welding bead formed on the metal container to detect significant flaws in the welding bead. This third inspection station 70 may employ a number of different inspection tools selected from the group comprising ultrasound, eddy current, laser and/or visual, as necessary, to detect any defects or deficiencies in the welding bead. After the step of inspecting the welding bead, the method includes a step of providing at least one controller 25 which is coupled with the carousel 20, and the second, third and fourth repair stations 60, 70 and 80, respectively. Thereafter, the method includes a step of individually operating the carousel 20 and second, third and fourth work stations 60, 70 and 80 from a remote location or work station 26 (FIG. 3) which is remote from the enclosure 12, and in a fashion so as to substantially seal the hazardous material 42 within the metal container 41 by means of a welding bead which has substantially no significant flaws. In the method of the present invention, and subsequent to the removal of any portion of the welding bead which has been identified as being defective and has been thereafter removed by the fourth work station 80, the method further includes an additional step of reapplication of the welding bead by the second work station 60. In this regard, the carousel 20 selectively rotates to a position where the region of the welding bead which has been previously removed by the fourth work station 80 may be reapplied and is thereafter reinspected by the third work station 70 to identify any remaining defects in the seal or welding bead. As earlier discussed, a remote operator, working from a work station 26 may, by means of wireless communication which is indicated, very generally, by the numeral 90, can communicate with the computer 24 in order to provide directions for the effective utilization of the assembly 10 and the effective sealing of the hazardous waste material 42 in the container 41.

### OPERATION

The operation of the described embodiment of the present invention 10 is believed to be readily apparent and is briefly summarized at this point.

An apparatus for sealing a container 10 of the present invention includes a first work station 40 for supporting a metal container 41 in a working position and which encloses a material 42 which emits hazardous radiation. A radiation shield 50 surrounds the first work station 40, and as seen in FIG. 2, a portion of the metal container extends above the radiation shield. A moveable carousel 20 is provided and which selectively rotates about the first work station 40. A second work station 60 is borne by the moveable carousel, and which mounts a remotely controllable welding apparatus or assembly 65 for forming a welding bead which seals the container 41. The welding apparatus or assembly is located in a position above the radiation shield 50 when the welding bead is being formed, and is further moveable to a protected position below the radiation shield when the welding apparatus is not forming the welding bead. The moveable carousel 20 selectively moves the welding apparatus around the metal container to form the welding bead. A third work station 70 is borne by the moveable carousel 20, and is positioned in spaced relation relative to the second work station 60. A remotely controllable inspection device 74 is borne by the third work station 70 and is positioned above the radiation shield, and is further configured to detect a defect in the welding bead formed by the second work station 60 when positioned above the radiation shield, and is further moveable to a protected position below the radiation shield 50 when the inspection device is not being employed to detect a defect in the welding bead. A fourth work station 80 is borne by the movable carousel 20, and which is positioned in spaced relation relative to the first and second work stations 40 and 60, respectively. A remotely controllable removal device, here shown as a grinder 84, is borne by the fourth work station 80, and is positioned above the radiation shield 50, and is configured to remove, at least in part, any defect which has been detected in the welding bead formed by the second work station 40, and is further moveable to a protected position below the radiation shield 50 when the removal device is not in use. A computer 24 is provided and is borne by the carousel 20 and which is substantially protected from the hazardous radiation emitted by the waste material 42 which is enclosed within the metal container 41 by the radiation shield 50. The computer 24 is coupled in controlling relation relative to the second, third and fourth work stations 60, 70 and 80, and further is controllably coupled to the rotatable carousel 20 in order to control the rotation of the carousel and therefore the position of the second, third and fourth work stations relative to the container 41 to be sealed. This relationship is seen in FIG. 3.

Therefore it will be seen that the method and apparatus 10 of the present invention provides a convenient means by which hazardous waste may be enclosed within a container, and effectively sealed thereby preventing the escape of the hazardous waste or radiation produced by same into the ambient environment.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. An apparatus for sealing a container, comprising:
a first work station which supports a container to be sealed;
a moveable carousel which rotates about the first work station;
a second work station borne by the moveable carousel, and which creates a seal on the container;
a third work station borne by the moveable carousel, and which inspects the seal made by the second work station and identifies any defect in the seal; and
a fourth work station borne by the moveable carousel, and which removes a region of the seal which includes the identified defect, and wherein the carousel selectively rotates to a position where the second work station can reapply the seal in the region of the seal which has been removed, and wherein subsequent to the reapplication of the seal, the carousel selectively rotates to a position where the region of the seal which has been previously removed, and reapplied is reinspected to identify any remaining defects in the seal.

2. An apparatus as claimed in claim 1, and wherein the container to be sealed encloses material which emits hazardous radiation.

3. An apparatus as claimed in claim 2, and further comprising:
an enclosure surrounding the moveable carousel and which substantially protects an operator from the hazardous radiation which is emitted by the material which is enclosed within the container.

4. An apparatus as claimed in claim 3, and wherein the container enclosing the material which emits the hazardous radiation is metal, and further includes a bottom portion which defines a cavity, and which receives the material which emits the hazardous radiation, and a cover which matingly cooperates with the bottom portion, and which encloses the material which emits the hazardous radiation within the cavity, and wherein the bottom portion of the container; and the cover when oriented in mating cooperation together define a seam therebetween.

5. An apparatus as claimed in claim 4, and wherein the seal created by the second work station is a welding bead which is deposited in the seam, and which is defined therebetween the bottom portion of the container, and the cover, and wherein the welding bead substantially sealably joins the bottom portion of the container, and the cover, and wherein the second work station mounts a welding assembly for depositing the welding bead in the seam.

6. An apparatus as claimed in claim 1, and further comprising:
a radiation shield which surrounds the work station, and wherein the second, third, and fourth work stations each have a moveable arm which selectively moves from a first sheltered position below the radiation shield, to a second exposed position above the radiation shield, and wherein in the second position, the moveable arm may selectively move into contact with the container.

7. An apparatus as claimed in claim 1, and wherein the container is fabricated at least in part from metal, and wherein the second work station mounts a welding assembly for welding the container closed, and wherein the welding assembly mounts an assembly for the concurrent inspection of a partially completed weld.

8. An apparatus as claimed in claim 7, and wherein the welding assembly mounts an ultrasonic generator which generates an ultrasonic signal which is passed, at least in part, through the partially completed weld.

9. An apparatus as claimed in claim 1, and further comprising:
a computer borne by the carousel and which is coupled in controlling relation relative to the second, third and fourth work stations, and wherein the container to be sealed encloses material which emits hazardous radiation, and wherein the computer is substantially shielded from any emitted hazardous radiation.

10. An apparatus as claimed in claim 1, and wherein the third work station permits the inspection of the seal which is being formed by the second work station from a remote location to facilitate the identification of the seal defects.

11. An apparatus as claimed in claim 1, and wherein the fourth work station mounts a grinder assembly which is operable to remove the region of the seal having any identified defect.

12. An apparatus as claimed in claim 10, and wherein the third work station utilizes one or more inspection tools selected from the group comprising ultrasonic energy, eddy current, laser and visual.

13. An apparatus for sealing a container, comprising:
a first work station for supporting a metal container in a working position, and which encloses a material which emits hazardous radiation;
a radiation shield which surrounds the first work station, and wherein a portion of the metal container extends above the radiation shield;
a moveable carousel which selectively rotates about the first work station;
a second work station, borne by the moveable carousel, and which mounts a remotely controllable welding apparatus for forming a welding bead which seals the container, and wherein the welding apparatus is located in a position above the radiation shield when the welding bead is being formed, and is further moveable to a protected position below the radiation shield when the welding apparatus is not forming the welding bead, and wherein the moveable carousel selectively moves the welding apparatus around the metal container to form the welding bead;
a third work station, borne by the moveable carousel, and which is positioned in spaced relation relative to the second work station, and wherein a remotely controllable inspection device is borne by the third work station and is positioned above the radiation shield, and is further configured to detect a defect in the welding bead formed by the second work station when positioned above the radiation shield, and is further moveable to a protected position below the radiation shield when the inspection device is not being employed to detect a defect in the welding bead;
a fourth work station, borne by the movable carousel, and which is positioned in spaced relation relative to the first and second work stations, and wherein a remotely controllable removal device is borne by the fourth work station, and is positioned above the radiation shield, and is configured to remove, at least in part, any defect which has been detected in the welding bead formed by the second work station, and is further moveable to a protected position below the radiation shield when the removal device is not in use; and
a computer borne by the carousel and which is substantially protected from the hazardous radiation emitted by the material enclosed within the metal container by the radiation shield, and wherein the computer is coupled in controlling relation relative to the second, third and fourth work stations.

14. An apparatus as claimed in claim 13, and wherein the metal container includes a bottom portion which defines a cavity, and which receives the material which emits the hazardous radiation, and a cover which matingly cooperates with the bottom portion, and which encloses the material which emits the hazardous radiation within the cavity, and wherein the bottom portion of the container, and the cover when oriented in mating cooperation together define a seam therebetween, and wherein the welding bead is deposited in the seam.

15. An apparatus as claimed in claim 13, and wherein the welding apparatus mounts an assembly which concurrently inspects the welding bead as it is being formed.

16. An apparatus as claimed in claim 13, and wherein the remotely controllable inspection device utilizes one or more inspection tools selected from the group comprising ultrasonic energy, eddy current, laser, and visual.

17. An apparatus as claimed in claim 13, and wherein the second and fourth work stations are moveable relative to the metal container in the X and Y axes.

18. An apparatus as claimed in claim 13, and wherein the removal device positioned in the fourth workstation is a remotely operable grinder which is configured to remove a region of the welding bead having the identified defect by implementing a grinding profile which is supplied by the computer to the grinder.

19. An apparatus as claimed in claim 13, and wherein an enclosure surrounds the carousel and which substantially protects a remote operator from the hazardous radiation emitted by the material in the container, and wherein the operator communicates with the computer, and controls the operation of carousel, and the work stations borne by the carousel by way of wireless communication.

20. A method for sealing a container, comprising:
providing a container to be sealed and which encloses waste material which emits hazardous radiation;
providing a carousel which selectively rotates about the container to be sealed;
providing a device which is borne by the carousel, and which is configured to seal the container; and
operating the carousel, and the device, from a remote location to seal the container, and prevent an operator from being exposed to the emitted hazardous radiation.

21. A method as claimed in claim 20, and wherein the container to be sealed is fabricated, at least in part from metal, and wherein the container is sealed by a welding bead.

22. A method as claimed in claim 21, and wherein the device which is configured to seal the container is a remotely controllable and moveable welding assembly.

23. A method as claimed in claim 22, and further comprising:
after the step of providing a device which is configured to seal the container, inspecting the welding bead formed by the welding assembly to detect any flaws in the partially completed welding bead.

24. A method as claimed in claim 23, and further comprising:
after the step of inspecting the welding bead formed by the welding apparatus to detect any flaws in the partially completed welding bead, removing a region of the welding bead which contains any identified welding bead flaws.

25. A method as claimed in claim 24, and further comprising:
after the step of removing a region of the welding bead, depositing a second welding bead in the region of the welding bead which has been removed; and
inspecting the second welding bead to detect any remaining welding bead flaws.

26. A method as claimed in claim 25, and further comprising:
providing a radiation shield which surrounds the container to be sealed.

27. A method as claimed in claim 26, and further comprising:
providing an enclosure surrounding the carousel, and which substantially protects a remote operator from any emitted hazardous radiation.

28. A method for sealing a container, comprising:
providing an enclosure which shields an operator from hazardous radiation;
providing a first work station within the enclosure, and which supports a metal container which must be sealed, and which encloses a material that emits hazardous radiation;
providing a carousel which selectively rotates about the first work station;
providing a second welding station, mounted on the carousel, and which is configured to seal the metal container by depositing a welding bead on the metal container;
providing a third inspection station, mounted on the carousel, and which inspects the welding bead formed on the metal container to detect any significant flaws in the welding bead;
providing a fourth removal station, mounted on the carousel, and which removes, at least in part, any of the significant flaws found in the welding bead;
providing at least one controller which is controllably coupled with the carousel, second, third, and fourth repair stations; and
individually operating the carousel, second, third and fourth work stations, from a location which is remote from the enclosure, and in a fashion so as to substantially seal the hazardous material within the metal container by means of a welding bead which has substantially no significant flaws.

29. A method as claimed in claim 28, and further comprising:
providing a radiation shield which surrounds the metal container and which defines a region which is sheltered from emitted radiation.

30. A method as claimed in claim 29, and wherein the inspection station employs an inspection tool selected from the group comprising ultrasound, eddy current, laser, or visual.
